(19) United States
(12) Patent Application Publication
(10) Pub. No.: US 2014/0307269 A1
(43) Pub. Date: Oct. 16, 2014

(54) DISPLAY CONTROL METHOD, DISPLAY APPARATUS, RECORDING MEDIUM, AND PRINTING SYSTEM

(71) Applicant: Seiko Epson Corporation, Tokyo (JP)

(72) Inventors: Naofumi Hirabayashi, Suwa-shi (JP); Minoru Kasahara, Tokyo (JP); Junpei Watanabe, Tokyo (JP)

(73) Assignee: Seiko Epson Corporation, Tokyo (JP)

(21) Appl. No.: 14/248,561

(22) Filed: Apr. 9, 2014

(30) Foreign Application Priority Data
Apr. 10, 2013 (JP) 2013-081902

(51) Int. Cl. G06K 15/02

(52) U.S. Cl. CPC G06K 15/025; G06K 15/024
USPC 358/1.6

(57) ABSTRACT

Provided is a display control method including: obtaining an attachment position image which is an image of an attachment position to which a label having a printing image printed on a printing medium is attached; generating a preview image of the label on which the printing image is printed; generating a synthesized image obtained by overlapping the attachment position image and the preview image; displaying the synthesized image on a display portion; receiving an operation from a user to change the synthesized image in a state where the synthesized image is displayed on the display portion; and displaying the changed synthesized image on the display portion, based on the operation in the receiving of the operation.

### CROSS REFERENCES TO RELATED APPLICATIONS

The entire disclosure of Japanese Patent Application No. 2013-081902, filed Apr. 10, 2013 is expressly incorporated by reference herein.

### BACKGROUND

1. Technical Field

The present invention relates to a display control program, a display control method, a display apparatus, and a printing system for displaying a synthetic image obtained by overlapping an image of an attachment position image to which a label is attached and a preview image of the label on a display portion.

2. Related Art

In the related art, a printing apparatus that includes a photographing portion and a touch panel display portion that displays an image photographed at the photographing portion, and creates a label by combining an image of an attachment position to which a label is attached with a preview image of the label before printing and by displaying the combined image on the touch panel display portion is known. The printing apparatus displays the preview image by adjusting the scale of the preview image to the scale of the attachment position image displayed on the touch panel display portion, and thereby, before printing the label, a user can confirm an attached image attached with the label to the attachment position at a same size balance as a actual size balance (refer to JP-A-2012-166511).

However, there is a case where the user does not seriously consider a size balance between the attachment position and the label and sets character input, font size, and the like. In this case, the user displays the attachment position image and the preview image on the touch panel display portion using the printing apparatus of the related art. As a result, the user does not obtain a good size balance between the attachment position image and the preview image in some cases. In the printing apparatus of the related art, it is not possible to change a relative size of the preview image with respect to the attachment position image. For this reason, even in a case where the size balance between the attachment position image and the preview image displayed on the touch panel display portion is not good, unless the character input and the font size are newly set, it is not possible to adjust the size balance between the attachment position image and the preview image. Therefore, before printing the label, the user is not able to confirm the attached image of which the size balance between the attachment position image and the preview image is adjusted.

### SUMMARY

An advantage of some aspects of the invention is to provide a display control method, a display apparatus, a recording medium, and a printing system that makes a size balance between an attachment position image and a preview image displayed on a display portion easily adjustable.

According to an aspect of the invention, there is provided a display control method including: obtaining the attachment position image which is an image of the attachment position to which a label having a printing image printed on the printing medium is attached; generating a preview image of the label on which the printing image is printed; generating a synthesized image obtained by overlapping the attachment position image and the preview image; displaying the synthesized image on the display portion; receiving an operation from a user to change the synthesized image in a state where the synthesized image is displayed on the display portion; and displaying the changed synthesized image on the display portion based on the operation in the receiving of the operation. In the receiving of the operation, the operation of the user to change a relative size of the preview image with respect to the attachment position image is received as a change of the synthesized image.

According to another aspect of the invention, there is provided a display apparatus including: a display portion; an attachment position image obtaining portion that obtains the attachment position image on which the label having the printing image printed on the printing medium is attached; a preview image generating portion that generates the preview image of the label on which the printing image is printed; a synthesized image generating portion that generates the synthesized image obtained by overlapping the attachment position image and the preview image; a display control portion that displays the synthesized image; and an operating portion that receives an operation from a user to change the relative size of the preview image with respect to the attachment position image in a state where the synthesized image is displayed on the display portion. The display control portion displays the changed synthesized image on the display portion based on the operation received by the operating portion.

In the display control method and a display apparatus, in a state where the synthesized image is displayed on the display portion, when the user performs an operation to change the relative size of the preview image with respect to the attachment position image, the changed synthesized image with the relative size is displayed on the display portion. For this reason, while confirming the synthesized image displayed on the display portion, the user can change the size balance between the attachment position image and the preview image. Therefore, the user can easily adjust the size balance between the attachment position image and the preview image that are displayed on the display portion. As a result, before printing the label, the user can confirm the attached image of which the size balance between the attachment position image and the preview image is adjusted.

In the above-described display control method, in the receiving of the operation, it is preferable that the operation from the user to change the preview image into a trapezoid shape be received as a change of the synthesized image in a case where the printing medium is rectangular.

In the display control method, when the user performs the operation to change the preview image into a trapezoid shape in a state where the synthesized image is displayed on the display portion, the preview image changed into a trapezoid shape is displayed on the display portion. For this reason, the user can change the preview image into a trapezoid shape, while confirming the synthesized image displayed on the display portion. Therefore, even in a case where there is a difference between trapezoidal distortion amount of the attachment position image displayed on the display portion and trapezoidal distortion amount of the preview image, it is possible to change the preview image into a trapezoid shape and eliminate awkwardness of the synthesized image such that both of the trapezoidal distortion amounts substantially match each other.

In the above-described display control method, it is preferable that creating printing data is performed such that a size ratio between the attachment position and the label is substantially the same as a size ratio between the attachment position image and the preview image after changing the relative size.

In the above-described display apparatus, it is preferable that a printing data creating portion that creates printing data such that a size ratio between the attachment position and the label is substantially the same as a size ratio between the attachment position image and the preview image after changing the relative size, and a data output portion that outputs the created printing data be further provided.

In the display control method and display control apparatus, the size of the printing image and the label is set such that the size ratio between the attachment position and the label is substantially the same as the size ratio between the attachment position image and the preview image after changing the relative size. Therefore, it is possible to print the label with a size in which the result of adjustment of the size balance between the attachment position image and the preview image is reflected.

According to still another aspect of the invention, there is provided a printing system of the invention including the above-described display apparatus and the printing apparatus that prints the printing image on the printing medium based on the output printing data.

In this configuration, the size ratio between the printed label and the attachment position is substantially the same as the size ratio between the attachment position image and the preview image after changing the relative size. Therefore, it is possible to obtain the label with the size in which the result of adjustment of the size balance between the attachment position image and the preview image is reflected.

### BRIEF DESCRIPTION OF THE DRAWINGS

The invention will be described with reference to the accompanying drawings, wherein like numbers reference like elements.

FIG. 1 is a configuration diagram of a printing system according to an embodiment of the invention.

FIG. 2 is a block diagram showing a control configuration of the printing system.

FIG. 3 is a diagram showing a main screen displayed on a display when a dedicated application program is operated in a portable terminal that is included in the printing system.

FIG. 4 is a diagram showing a printing preview screen displayed on the display of the portable terminal.

FIG. 5A is a diagram showing an example of a synthesized image obtained by overlapping an attachment position image and a preview image, and FIG. 5B is a diagram showing status when the user is imaging the attachment position.

FIG. 6A is a diagram of a synthesized image that is reduced from the preview image shown in FIG. 5A, and FIG. 6B is a diagram of the synthesized image that displays the preview image shown in FIG. 5A at a real size.

FIG. 7A is a diagram showing another example of the synthesized image obtained by overlapping the attachment position image and the preview image, and FIG. 7B is a diagram showing a status when the user is imaging the attachment position.

FIG. 8A is a diagram of the synthesized image that is reduced from the preview image shown in FIG. 7A, and FIG. 8B is a diagram of the synthesized image changed from the preview image shown in FIG. 7B into a trapezoid shape.

### DESCRIPTION OF EXEMPLARY EMBODIMENTS

Hereinafter, one embodiment of a display control method, a display apparatus, a recording medium, and a printing system according to the invention will be described with reference to the attached drawings.

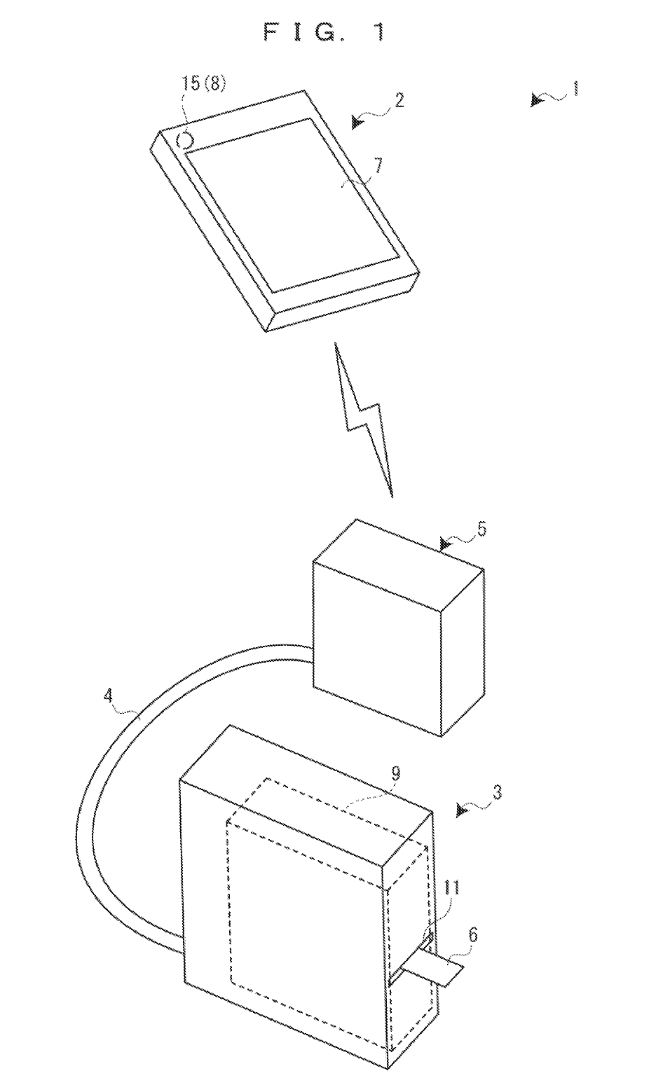

FIG. 1 is a configuration diagram of a printing system according to an embodiment of the invention.

As shown in FIG. 1, the printing system 1 of the embodiment includes a portable terminal 2 as the display apparatus and a tape printing apparatus 3. The tape printing apparatus 3 is wirelessly connected and able to communicate with the portable terminal 2 through a wireless Local Area Network (LAN) router 5 connected by a Universal Serial Bus (USB) cable 4, for example. That is, the wireless LAN router 5 functions as a print server. The tape printing apparatus 3 and the portable terminal 2 also may be configured to be directly connected in a wireless or wired manner without connecting through the wireless LAN router 5.

The portable terminal 2 is installed with a dedicated application program for performing a series of processes from the display control method (to be described) and text editing to printing data output. The portable terminal 2 transmits the printing data of the printing image edited by a user using the dedicated application program to the tape printing apparatus 3. The tape printing apparatus 3 performs printing onto a tape-shaped member 6 and creates a label, based on the printing data transmitted from the portable terminal 2. The dedicated application program is downloaded from a predetermined server (for example, web site). That is, it is possible to store the dedicated application program in various recording mediums (CD-ROM, flash memory, or the like) and provide the same.

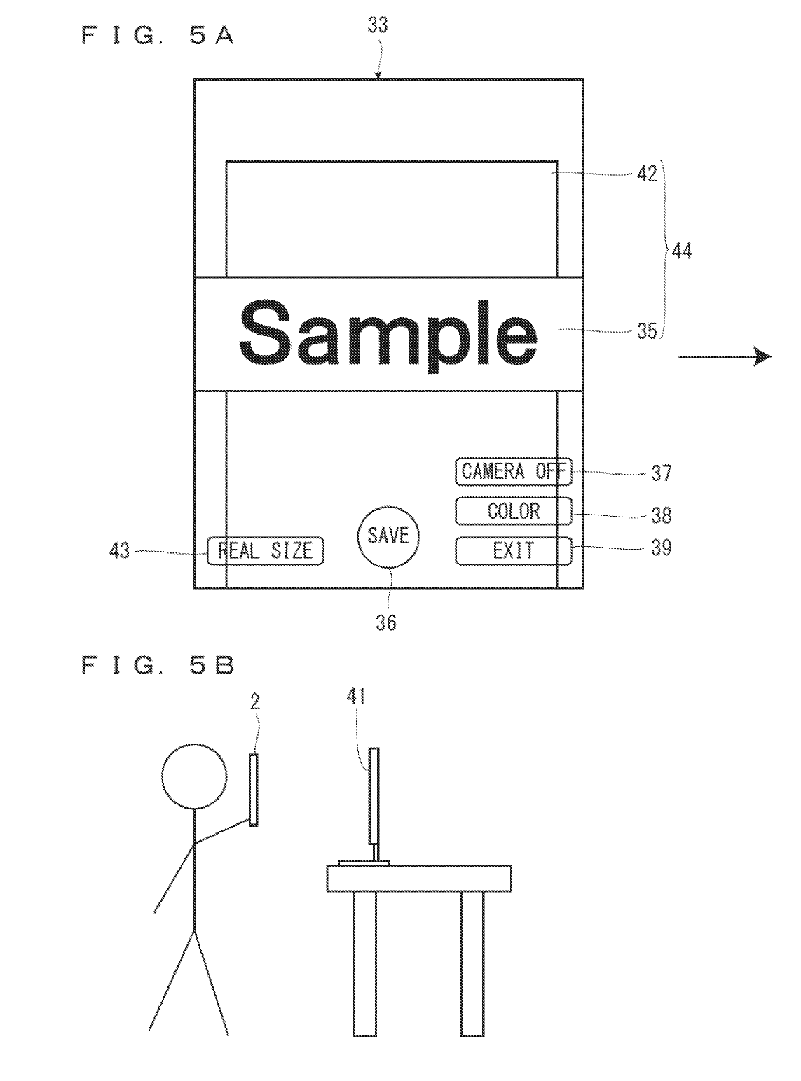

The portable terminal 2 is a tablet terminal or a smart phone, and includes a touch panel type display 7 and a camera module 15 (imaging lens 8). The details of the portable terminal 2 will be described later. The portable terminal 2 overlaps a preview image 35 of the label with an image (attachment position image 42) imaged by the camera module 15 and displays the overlapped image on the touch panel type display 7 (refer to FIGS. 5A and 5B or the like).

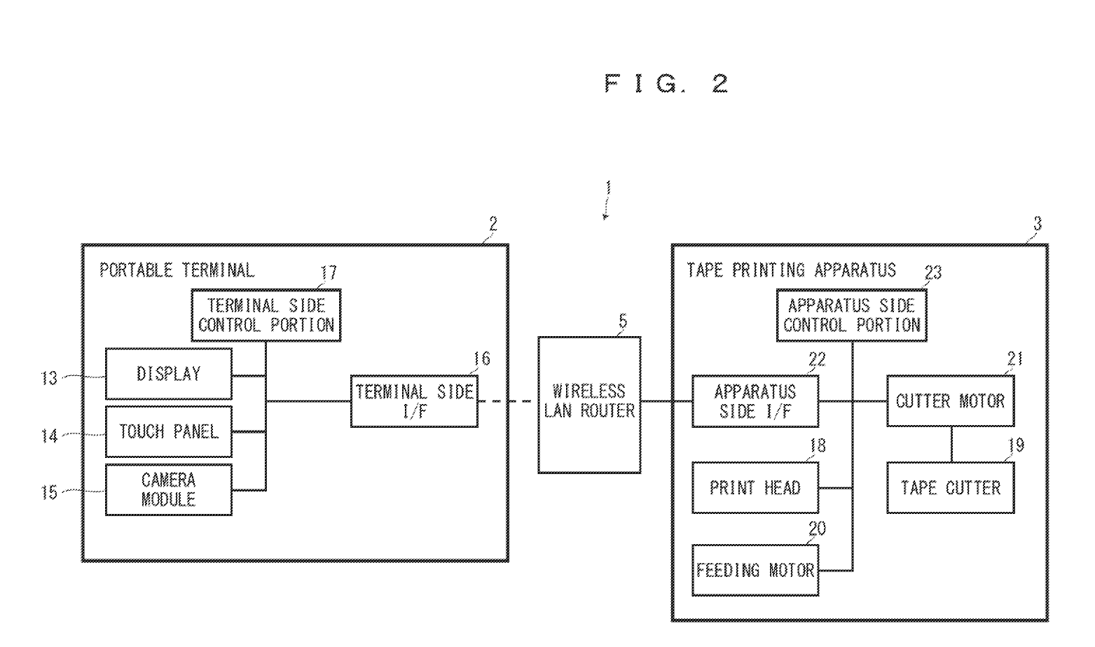

The tape printing apparatus 3 is configured to have a cartridge 9 which is attachable and detachable. The cartridge 9 includes the tape-shaped member 6 as a printing medium, an ink ribbon (not shown), a platen roller, and a cartridge case accommodating the tape-shaped member 6, the ink ribbon, and the platen roller. The tape printing apparatus 3 delivers the tape-shaped member 6 from the cartridge 9 to a tape outlet 11 based on the printing data received from the portable terminal 2, and performs the printing process. A printed part of the tape-shaped member 6 is cut off by a tape cutter 19 (refer to FIG. 2) provided in the tape printing apparatus 3, or by a pair of scissors separate from the tape printing apparatus 3. The cut-off tape piece is used as the label. In addition, the tape-shaped member 6 having various different types of tape width or color is prepared in the cartridge 9. The tape-shaped member 6 is an adhesive tape with a detachable sheet, for example.

FIG. 2 is a block diagram showing a control configuration of the printing system.

Next, the control configuration of the printing system 1 will be described with reference to FIG. 2. The portable terminal 2 includes a display 13 (display portion) that constitutes the above-described touch panel type display 7, a touch panel 14 (operating portion), the camera module 15, a terminal side interface 16, and a terminal side control portion 17.

The display 13 displays various images based on a control signal from the terminal side control portion 17. The touch panel 14 is provided on the display 13, detects a touch operation (so called tapping, flipping, pitching, dragging or the like) by the user on the screen, and outputs the detection result to the terminal side control portion 17.

The camera module 15 is configured with the imaging lens 8, a image sensor, and the like, images (photographs) a still image and a moving image, and outputs the obtained image signal to the terminal side control portion 17.

The terminal side interface 16 (data output portion) performs the wireless communicating between the terminal side interface 16 and the wireless LAN router 5, outputs the printing data, and performs transmitting and receiving various commands and statuses.

The terminal side control portion 17 is configured with a Central Processing Unit (CPU), a Read Only Memory (ROM), a Random Access Memory (RAM), and the like. A control program or the above-described dedicated application program is recorded in the ROM. The CPU performs various calculation processes according to the control program or the dedicated application program recorded in the ROM. The RAM is used as a work area when the CPU performs various calculation processes.

Meanwhile, the tape printing apparatus 3 includes a feeding motor 20, a print head 18, the tape cutter 19, a cutter motor 21, an apparatus side interface 22, and an apparatus side control portion 23.

The feeding motor 20 rotates and drives the platen roller of the mounted cartridge 9. The print head 18 is a thermal type. The print head 18 and the platen roller cooperate together, deliver the tape-shaped member 6 and the ink ribbon interposed between the print head 18 and the platen roller, and perform printing of the printing data received from the portable terminal 2 onto the tape-shaped member 6. The tape cutter 19 cuts the transported tape-shaped member 6 in a tape width direction. The cutting performed by the tape cutter 19 is driven by the cutter motor 21.

The apparatus side interface 22 is configured with a USB interface or the like, receives the printing data, and performs transmitting and receiving of various commands and statuses. The apparatus side control portion 23 is configured with the CPU, the ROM, the RAM, and the like, and controls each part of the tape printing apparatus 3.

In the printing system 1 configured as above, when the user commands printing after editing the text, the terminal side control portion 17 generates the printing data, and the generated printing data is output from the terminal side interface 16 in the portable terminal 2. In the tape printing apparatus 3, the feeding motor 20 and the print head 18 are driven and controlled by the apparatus side control portion 23 based on the received printing data. As a result, the printing image on the tape-shaped member 6 is printed. In addition, the cutter motor 21 is driven and controlled by the apparatus side control portion 23 based on the printing data. The tape cutter 19 cuts off the printed part of the transported tape-shaped member 6. In this manner, the tape printing apparatus 3 creates the label on which the predetermined printing image is printed.

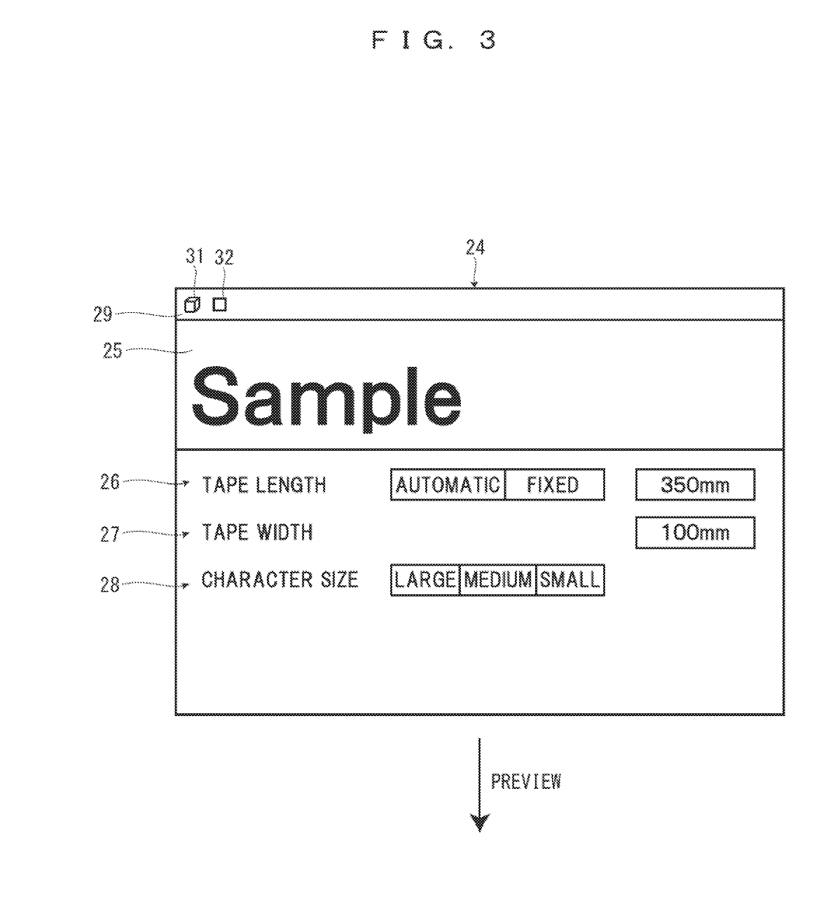

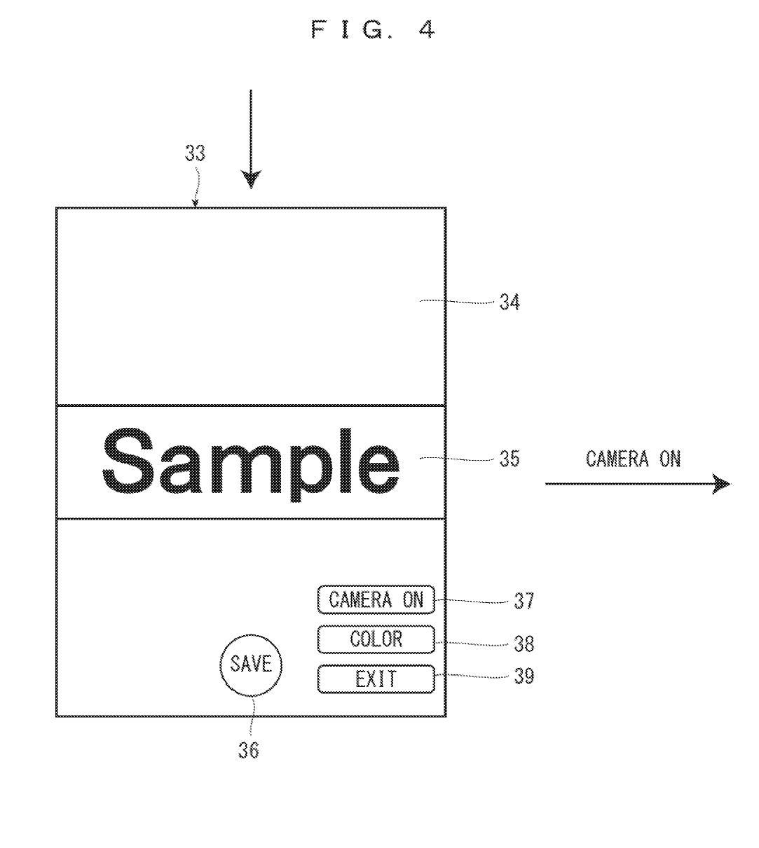

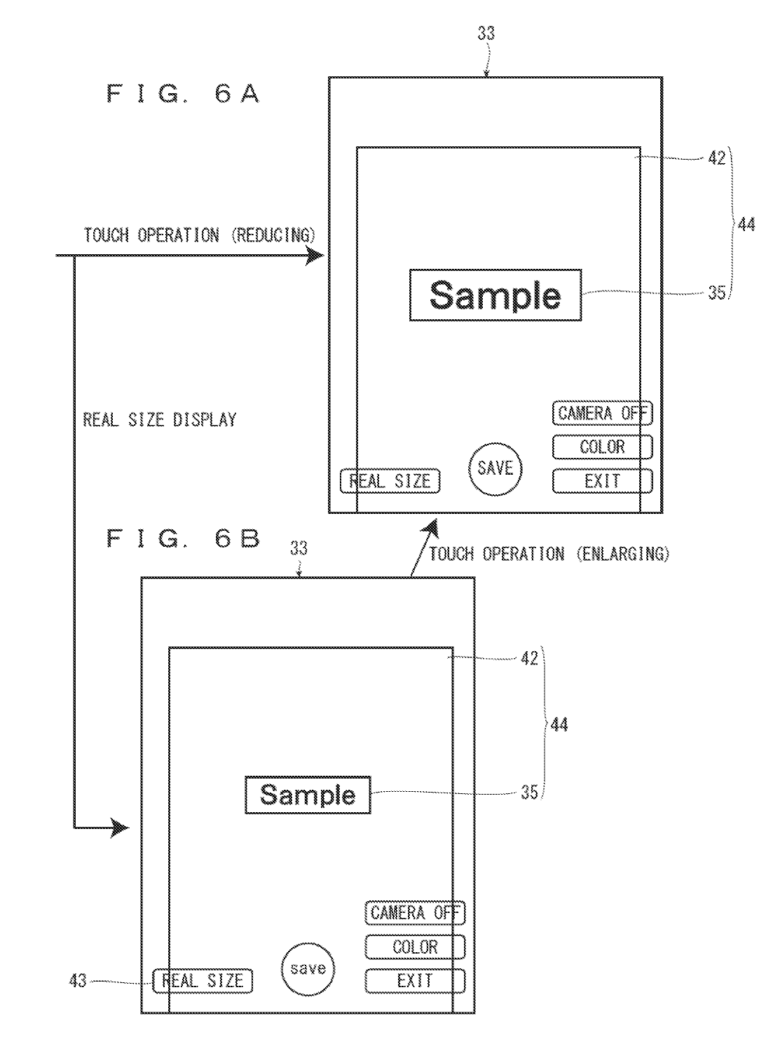

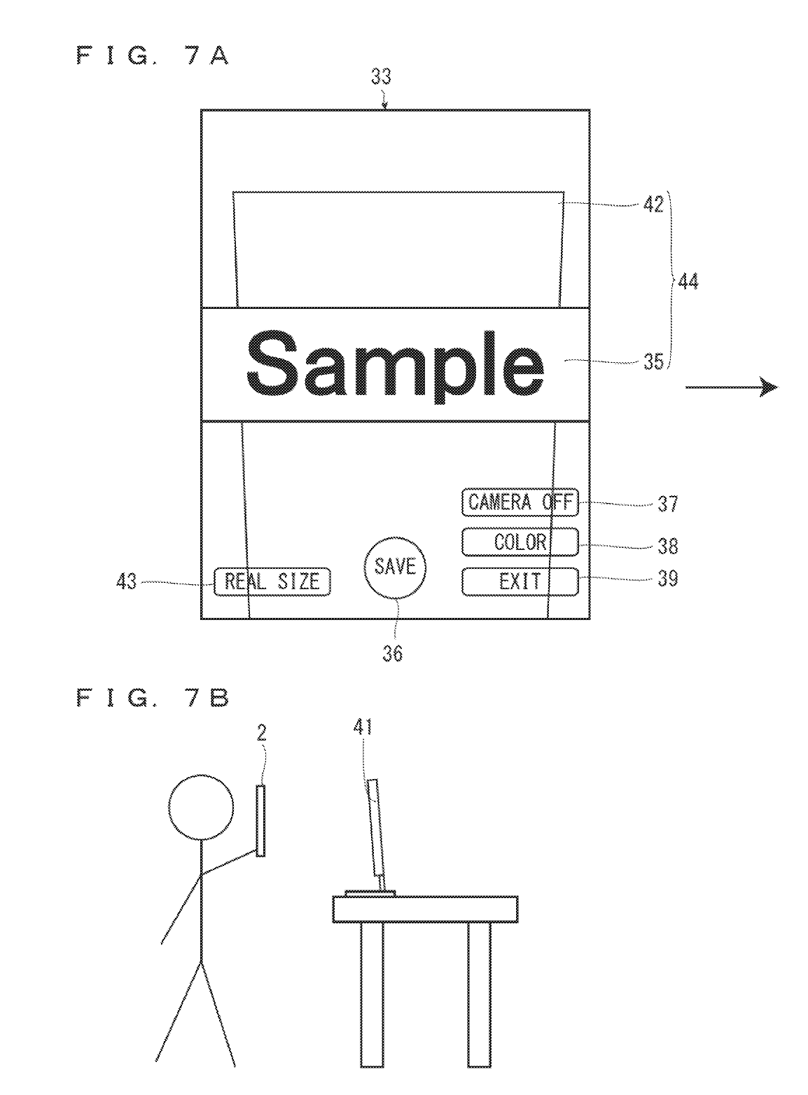

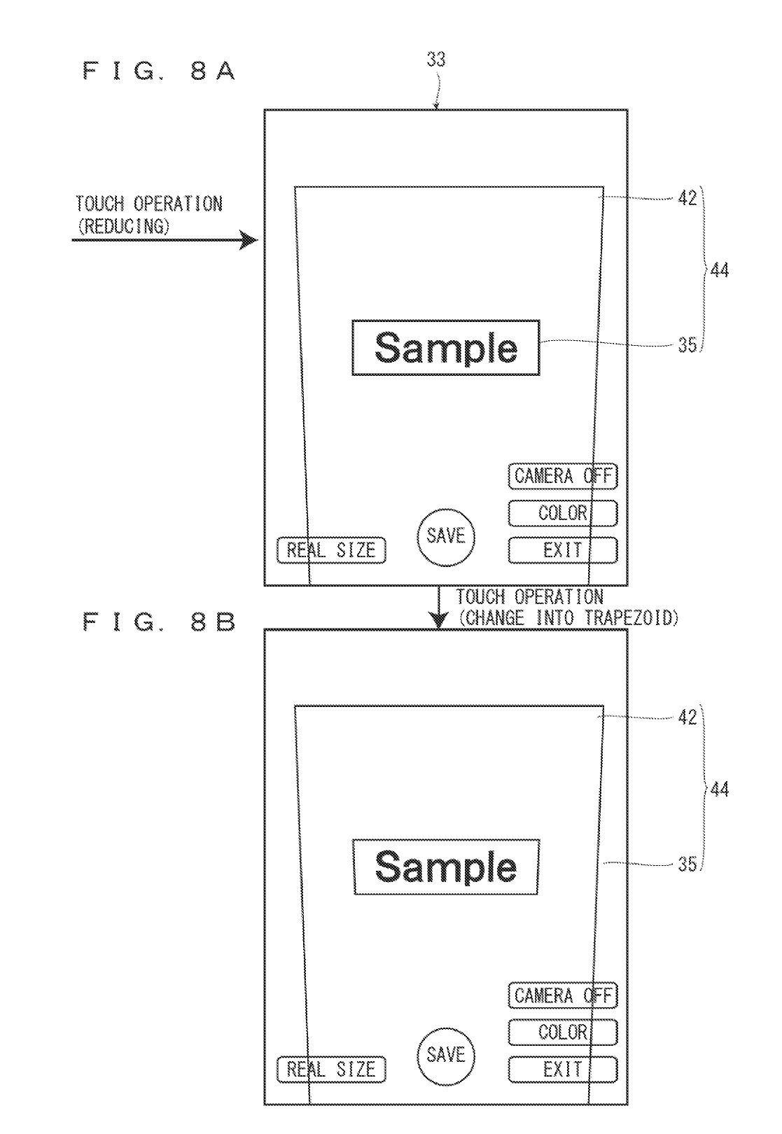

FIG. 3 is a diagram showing a main screen displayed on the display when the dedicated application program is operated in the portable terminal that is included in the printing system. FIG. 4 is a diagram showing the printing preview screen displayed on the display of the portable terminal. FIG. 5A is a diagram showing an example of the synthesized image obtained by overlapping the attachment position image and the preview image. FIG. 5B is a diagram showing a status when the user is imaging the attachment position. FIG. 6A is a diagram of the synthesized image that is reduced from the preview image shown in FIG. 5A. FIG. 6B is a diagram of the synthesized image that displays the preview image shown in FIG. 5A at a real size. FIG. 7A is a diagram showing another example of the synthesized image obtained by overlapping the attachment position image and the preview image. FIG. 7B is a diagram showing a status when the user is imaging the attachment position. FIG. 8A is a diagram of the synthesized image that is reduced from the preview image shown in FIG. 7A. FIG. 8B is a diagram of the synthesized image changed from the preview image from FIG. 8A into a trapezoid shape.

Next, with reference to FIGS. 3 to 8B, a series of processes from the display control method and text editing to printing data output performed by the portable terminal 2 will be described in detail. First, when the user operates the dedicated application program, the terminal side control portion 17 displays the main screen 24 on the display 13 (refer to FIG. 3).

The main screen 24 is provided with a text editing area 25, a tape length setting area 26, a tape width setting area 27, a character size setting area 28, a toolbar 29, and the like.

The text editing area 25 is an area for editing the text to be printed by the user. For example, when the user taps the text editing area 25, a software keyboard (not shown) is displayed, and it is possible to edit the text. Here, a text “SAMPLE” is input and edited.

The tape length setting area 26 is an area for setting the tape length (length of the label). It is possible to select “AUTOMATIC” that changes the tape length according to the length of the text (number of characters), or “FIXED” in which the tape length is designated by the user.

The tape width setting area 27 is an area for setting the tape width (width of the label). It is possible to select the tape width from among the various prepared tape widths according to the tape width to be used.

The character size setting area 28 is an area for setting the size of the character to be printed. It is possible to select one of three sizes of “LARGE”, “MEDIUM”, and “SMALL.”

The toolbar 29 is provided with a printing icon 31 for commanding printing, a preview icon 32 for displaying the preview screen, and the like.

When the user taps the preview icon 32 after setting the text editing, the tape length, and the like, the terminal side control portion 17 displays a printing preview screen 33 as a preview image generating portion on the display 13. The preview image 35 of the label is displayed at the center of a solid-colored background image 34 in the printing preview screen 33.

Above all, the printing preview screen 33 is provided with a save button 36, a camera ON/OFF button 37, a color setting button 38, and an exit button 39. The save button 36 is for imaging and saving a picture (still image). The camera ON/OFF button 37 is for driving the camera module 15, as will be described later. The color setting button 38 is for changing a tape color and a character color in the preview image 35. The exit button 39 is for closing the printing preview screen 33 and returning to the main screen 24.

Here, the terminal side control portion 17 calculates the size (for example, actual size) of the preview image 35 based on the tape length and the tape width set on the main screen 24 (refer to FIG. 4). In the tape length setting area 26, in a case where “AUTOMATIC” is set, the terminal side control portion 17 calculates the tape length by using the text length input into the text editing area 25 and the character size set in the character size setting area 28.

Next, when the user taps the camera ON/OFF button 37 on the attachment position 41 (for example, a surface opposite to the display surface of the display apparatus) on which the label is attached in a state where the attachment position 41 is facing the imaging lens 8 of the camera module 15 (refer to FIG. 5B), the terminal side control portion 17 drives the camera module 15 as the attachment position image obtaining portion. In the printing preview screen 33 as the synthesized image generating portion, the terminal side control portion 17 switches the background image 34 to the attachment position image 42 (real-time image) imaged by the camera module 15, and displays a real size display button 43 (refer to FIG. 5A). That is, on the display 13, a synthesized image 44 is displayed by overlapping the preview image 35 as the synthesized display portion and the attachment position image 42.

In addition, the user may perform the below-described operation with the real-time image as it is, and may perform the below-described operation on the imaged and saved still image by tapping the save button 36.

In a state where the synthesized image 44 is displayed on the display 13, the terminal side control portion 17 receives the touch operation with respect to the touch panel 14 for changing the preview image 35. Therefore, the terminal side control portion 17 displays the changed preview image 35 on the display 13 based on the touch operation of the user detected by the touch panel 14.

The operation of changing the preview image 35 includes the touch operation of enlarging and reducing the preview image 35 with respect to the preview image 35, the touch operation of displaying the preview image 35 at a real size with respect to the real size display button 43, and the touch operation of changing the preview image 35 into a trapezoid shape with respect to the preview image 35.

When the user performs the touch operation (for example, gridding a corner part or a side of the preview image 35) of enlarging and reducing the preview image 35 with respect to the preview image 35, for example, in the synthesized image 44, even in a case where the preview image 35 displayed at a real size is too large with respect to the attachment position image 42 (refer to FIG. 5A), it is possible to reduce and display the preview image 35 (refer to FIG. 6A).

In addition, by performing the touch operation (tapping or the like) of displaying the preview image 35 at a real size with respect to the real size display button 43, it is possible to display the preview image 35 at the same display magnification as the display magnification of the attachment position image 42. That is, when the user taps the real size display button 43, the terminal side control portion 17 calculates the display magnification of the attachment position image 42. Then, the terminal side control portion 17 displays the preview image 35 on the display 13 at the same display magnification as the calculated display magnification of the attachment position image 42 (refer to FIG. 6B).

Moreover, for example, a imaging distance and a imaging angle are obtained by using the position of the focus lens that constitutes the imaging lens 8, and by using the obtained imaging distance and the imaging image, a dimension of a imaging range in the imaging distance is obtained. Then, it is possible to calculate the display magnification by obtaining a ratio between the dimension of the obtained imaging range and the dimension of the display range of the display 13.

Even after displaying the preview image 35 at a real size, the user can further change the preview image 35. For example, in a case where the preview image 35 displayed at a real size is too small with respect to the attachment position image 42 (refer to FIG. 6B), it is possible to enlarge and display the preview image 35 when the user performs the touch operation of enlarging the preview image 35 (refer to FIG. 6A).

In this manner, in a state where the synthesized image 44 is displayed on the display 13, the user performs the operation of enlarging and reducing the preview image 35, or displaying the preview image 35 at a real size, and thereby the synthesized image 44, of which the relative size of the preview image 35 with respect to the attachment position image 42 is changed, is displayed on the display 13. For this reason, while confirming the synthesized image 44 displayed on the display 13, the user can change the size balance between the attachment position image 42 and the preview image 35. Therefore, the user can easily adjust the size balance between the attachment position image 42 and the preview image 35 displayed on the display 13. For this reason, before printing the label, the user can confirm the attached image of which the size balance between the attachment position image 42 and the preview image 35 is adjusted.

In the embodiment, the preview image 35 is enlarged or reduced. However, the relative size of the preview image 35 with respect to the attachment position image 42 may be changed by enlarging or reducing the attachment position image 42.

After adjusting and confirming the size balance, if the user taps the exit button 39 on the printing preview screen 33, the terminal side control portion 17 closes the printing preview screen 33 and displays the main screen 24 again on the display 13 (refer to FIG. 3). Then, if the user taps the printing icon 31, the terminal side control portion 17 creates the printing data.

Here, the terminal side control portion 17 creates the printing data at a size based on the tape length and the tape width set on the main screen 24. For example, in a case where the tape length and the tape width set on the main screen 24 are 350 mm and 100 mm, respectively, the printing data is also created in such a manner that the tape length and the tape width of the label size become 350 mm and 100 mm, respectively.

However, regardless of the tape length and the tape width set on the main screen 24, the terminal side control portion 17 may create the printing data such that the size ratio between the attachment position 41 and the label is the same as the size ratio between the attachment position image 42 and the preview image 35 after the relative size is changed.

For example, the terminal side control portion 17 calculates the change rate of the label size, based on the display magnification of the attachment position image 42, the display magnification of the preview image 35 right before enlarging or reducing by the touch operation, and the enlargement or reduction rate of the preview image 35. The printing data is created based on the change rate of the calculated label size. More specifically, in a case where the tape length of the preview image 35 displayed at a real size (100% of the display magnification) is reduced to 90% by the touch operation with respect to the attachment position image 42 displayed at 60% of the display magnification, the terminal side control portion 17 calculates the change rate of the label size (tape length) at 150% (0.9/(0.6/1)=1.5). In this case, if the tape length set on the main screen 24 is 350 mm, the terminal side control portion 17 creates the printing data in such a manner that the real tape length becomes 525 mm. As a result, it is possible to print the label of which the size is reflected by the adjustment result of the size balance between the attachment position image 42 and the preview image 35. Not only the tape length, but also the tape width may be changed to the most appropriate tape width.

Furthermore, it is possible to change the preview image 35 into a trapezoid shape by performing the touch operation (for example, dragging the corner part of the preview image 35) of changing the preview image 35 into a trapezoid shape with respect to the preview image 35, as an operation of changing the preview image 35.

More specifically, in the synthesized image 44, there is a case where the attachment position image 42 is distorted into a trapezoid shape because the attachment position 41 is imaged in a slanted manner (refer to FIG. 7B) in contrast to the preview image 35 being displayed in a rectangular shape (refer to FIGS. 7A and 8A). In this case, it is possible to display the preview image 35 changed into a trapezoid shape by performing the touch operation of changing the preview image 35 into a trapezoid shape by the user such that the trapezoidal distortion amount of the preview image 35 is the same as that of the attachment position image 42 (refer to FIG. 8B).

In addition, in the printing preview screen 33, by displaying the button or the like for changing the image into a trapezoid shape and by tapping the button, the terminal side control portion 17 may automatically change the preview image 35 into a trapezoid shape.

In this manner, in a state where the synthesized image 44 is displayed on the display 13, the preview image 35 changed into a trapezoid shape is displayed on the display 13 when the user performs the operation of changing the preview image 35 into a trapezoid shape. For this reason, while confirming the synthesized image 44 displayed on the display 13, the user can change the preview image 35 into a trapezoid shape. Therefore, even in a case where the trapezoidal distortion amount of the attachment position image 42 displayed on the display 13 and the trapezoidal distortion amount of the preview image 35 are different from each other, it is possible to change the preview image 35 into a trapezoid shape and eliminate awkwardness of the synthesized image 44 such that both of the trapezoidal distortion amounts substantially match each other.

In this manner, according to the printing system 1 of the embodiment, it is possible to easily adjust the size balance between the attachment position image 42 and the preview image 35 displayed on the display 13. In addition, the printing medium is not limited to the tape-shaped member 6, and may have a predetermined size such as a size of a Plain Paper Copier (PPC) sheet. In addition, it is not necessary that the attachment position image 42 be imaged by the camera module 15 provided with the portable terminal 2. The attachment position image 42 may be an image imaged by another imaging apparatus and displayed on the display 13 of the portable terminal 2. Furthermore, the display apparatus is not limited to the portable terminal 2, and may be a personal computer or the like provided with a display (display portion). In the embodiment, the configuration that transmits the printing data generated by the portable terminal 2 to the tape printing apparatus 3 as the printing system 1 is applied. However, the invention is not limited thereto, and the printing system 1 may be configured with the tape printing apparatus 3 performing from image editing to printing/cutting processing, as a stand-alone device.

What is claimed is:

1. A display control method comprising:
obtaining an attachment position image which is an image of an attachment position to which a label having a printing image printed on a printing medium is attached;
generating a preview image of the label on which the printing image is printed;
generating a synthesized image obtained by overlapping the attachment position image and the preview image;
displaying the synthesized image on a display portion;
receiving an operation from a user to change the synthesized image in a state where the synthesized image is displayed on the display portion; and
displaying the changed synthesized image on the display portion, based on the operation in the receiving of the operation.

2. The display control method according to claim 1,
wherein, in the receiving of the operation, the operation from the user to change a relative size of the preview image with respect to the attachment position image is received as a change of the synthesized image.

3. The display control method according to claim 2, further comprising:
creating printing data in which a size ratio between the attachment position and the label is substantially the same as a size ratio between the attachment position image and the preview image after changing the relative size.

4. The display control method according to claim 1,
wherein, in the receiving of the operation, the operation from the user to change the preview image into a trapezoid shape is received as a change of the synthesized image in a case where the printing medium is rectangular.

5. A display apparatus comprising:
a display portion;
an attachment position image obtaining portion that obtains an image of the attachment position image to which a label having a printing image printed on a printing medium is attached;
a preview image generating portion that generates a preview image of the label on which the printing image is printed;
a synthesized image generating portion that generates a synthesized image obtained by overlapping the attachment position image and the preview image;
a display control portion that displays the synthesized image; and
an operating portion that receives an operation from a user to change the preview image with respect to the attachment position image in a state where the synthesized image is displayed on the display portion,
wherein the display control portion displays the changed synthesized image on the display portion based on the operation received by the operating portion.

6. The display apparatus according to claim 5,
wherein the operating portion receives the operation from the user to change a relative size of the preview image with respect to the attachment position image as the change of the synthesized image.

7. The display apparatus according to claim 6, further comprising:
a printing data creating portion that creates printing data such that a size ratio between the attachment position and the label is substantially the same as a size ratio between the attachment position image and the preview image after changing the relative size; and
a data output portion that outputs the created printing data.

8. The display apparatus according to claim 5,
wherein the operating portion receives the operation from the user to change the preview image into a trapezoid shape as the change of the synthesized image in a case where the printing medium is rectangular.

9. A printing system comprising:
the display apparatus according to claim 5; and
a printing apparatus that prints the printing image on the printing medium based on the output printing data.

10. A non-transitory computer readable recording medium on which a program causing a computer to execute the display control method according to claim 1 is recorded.
